(19) United States
(12) Patent Application Publication
(10) Pub. No.: US 2004/0208508 A1
(43) Pub. Date: Oct. 21, 2004

(54) Optical signal reception control circuit and method for controlling reception of optical signal

(76) Inventor: Takayuki Tanaka, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/234,171

(22) Filed: Sep. 5, 2002

(30) Foreign Application Priority Data
Mar. 7, 2002 (JP) 061649/2002

(51) Int. Cl. H04B 10/06

(52) U.S. Cl. 398/19

(57) ABSTRACT

An optical signal reception control circuit which includes an identifying circuit which identifies data included in a burst optical signal and which outputs data and an envelope generating circuit which detects the start of reception of the burst optical signal and which outputs an envelope signal corresponding to a reception period of the burst optical signal. The optical signal reception control circuit also includes a fixed signal output circuit which outputs a fixed signal of a predetermined level for a null signal period in which the data is not included and a selector which selects the output of the identifying circuit when the envelope signal is outputted and which selects the output of the fixed signal output circuit when the envelope signal is not outputted.

### BACKGROUND OF THE INVENTION

1. Field of the Invention

The present invention generally relates to an optical signal reception control circuit for controlling received outputs in a burst optical signal (corresponding to a packet optical signal intermittently transmitted with a null signal interval interposed therein) employed in a PON (Passive Optical Network), and a method of controlling reception of an optical signal.

This application relies for priority on Japanese patent application, Serial Number 61649/2002, filed Mar. 7, 2002, which is incorporated herein by reference in its entirety

2. Description of the Related Art

FIG. 9 is a diagram showing a configuration of a conventional optical signal receiving device. The optical signal receiving device comprises a photodiode 1, a pre-amplifier 2, and an ATC (Automatic Threshold Control) circuit (level identifying circuit) 3. The ATC circuit 3 includes a differential amplifier 4, a comparator 5, peak detector circuits 6 and 7, and adders 8 and 9.

A level identifying circuit for adjusting an identification level (threshold level for determining the value of receive data) of a receive signal to the optimum level is indispensable to an optical signal device for receiving a burst optical signal, such as a PON in order to properly determine the received data values. In the optical signal receiving device shown in FIG. 9, the photodiode 1 receives an optical signal therein and converts it to a current signal. The pre-amplifier 2 converts the current signal to a voltage signal, and the ATC circuit 3 obtains the optimum identification level (central level of signal amplitude in general) of the voltage signal.

FIG. 10 is a timing chart of the ATC circuit 3. In the ATC circuit 3, a signal INPUT shown in FIG. 10(a), which is outputted from the pre-amplifier 2, is inputted to the differential amplifier 4. The differential amplifier 4 generates signals A and NA with a reference voltage Vref1 shown in FIG. 10(b) as the center. The differential amplifier 4 outputs the signal A to the peak detector circuit 7 and the adder 8 and outputs the signal NA to the peak detector circuit 6 and the adder 9. The peak detector circuit 6 detects the peak of the signal NA and outputs a signal NAP shown in FIG. 10(c) to the adder 8. The peak detector circuit 7 detects the peak of the signal A and outputs a signal AP shown in FIG. 10(c) to the adder 9. The adder 8 adds the signals A and NAP with a reference voltage Vref2 as the reference, and outputs a signal B shown in FIG. 10(d) to the comparator 5. Further, the adder 9 adds the signals NA and AP with the reference voltage Vref2 as the reference and outputs a signal NB shown in FIG. 10(d) to the comparator 5. The comparator 5 compares the level of the signal B and that of the signal NB to thereby identify “0” and “1” (“H” and “L”) of receive data and outputs signals OUT and NOUT shown in FIG. 10(e).

Thus, the ATC circuit 3 generates positive and negative signals A and NA with the reference voltage Vref1 as the center from the input signal INPUT, detects the peaks of these signals A and NA respectively, adds the signal A and a peak detection signal NAP (peak detection signal of signal NA), and the signal NA and a peak detection signal AP (peak detection signal of signal A), respectively, with the reference voltage Vref2 as the reference, compares add signals B (added signal of signals A and NAP) and NB (added signal of signals NA and AP), and obtains output signals OUT and NOUT.

Since the adders 8 and 9 are configured with the same reference voltage Vref2, as the reference in the ATC circuit 3, the signals B and NB becomes identical in level as shown in FIG. 10(d) during a signal-free or null signal period (period in which no burst optical signal is received).

FIG. 11 is a diagram showing a configuration of another conventional optical signal receiving device, which has been described in, for example, Japanese Laid Open Patent Application No. Hei 10(1998)-163828. The optical signal receiving device shown in FIG. 11 is one wherein the ATC circuit 3 employed in the conventional optical signal receiving device shown in FIG. 9 is changed to an ATC circuit 103. The ATC circuit 103 shown in FIG. 11 is equivalent to one in which a reference voltage (offset voltage) Vref3 is provided in the ATC circuit 3 shown in FIG. 9.

FIG. 12 is a timing chart of the ATC circuit 103. Incidentally, FIG. 12(a) through 12(c) are identical to FIGS. 10(a) through 10(c). In the ATC circuit 103, an adder 8 adds signals A and NAP with a reference voltage Vref2 as the reference in a manner similar to the adder 8 shown in FIG. 9 and outputs a signal B shown in FIG. 12(d), whereas an adder 9 is different from the adder 9 shown in FIG. 9. The adder 9 adds signals NA and AP with reference voltages Vref2+Vref3 as the reference and outputs a signal NB shown in FIG. 12(d). A comparator 5 compares the levels of the signals B and NB and outputs signals OUT and NOUT shown in FIG. 12(e).

Since the offset voltage Vref3 is provided for the ATC circuit 103, the signals B and NB are different in level from each other as shown in FIG. 12(d) even during a null signal period.

However, the prior arts are accompanied by problems to be described below in terms of the sensitivity of reception of optical signals and noise produced during signal-free periods respectively.

The ATC circuit 3 shown in FIG. 9 is accompanied by a problem that since the input signals B and NB of the comparator 5 become identical in level during the null signal period, the comparator 5 oscillates and thereby outputs their oscillations as noise.

On the other hand, since the offset voltage Vref3 is provided so as to make the levels of the signals B and NB different from each other during the null signal period in the ATC circuit 103 shown in FIG. 11, the comparator 5 does not oscillate even during the null signal period and thereby generates no noise.

However, the ATC circuit 103 shown in FIG. 11 involves a problem that since the level of the signal NB is shifted as shown in FIG. 12(d) owing to the provision of the offset voltage Vref3, a level identification allowance at the time that the signal B is taken “H” and the signal NB is taken “L”, is reduced (the sensitivity of reception is degraded). Also a problem arises in that when the level of the received optical signal reaches a local minimum (near the minimum level of light-received signal), the signal level cannot be determined, so that specs for an optical signal transmission module and an optical signal receiving device would not be met.

Further, each of the ATC circuit 3 and the ATC 103 is accompanied by a problem that when the reception of the burst optical signal is completed, the peak detector circuit 7 is discharged and hence the level of the signal AP drops according to a discharge time constant of the peak detector circuit 7 from the completion of the reception of the burst optical signal, whereby rebound noise is produced. As the amplitude of the input signal INPUT increases, large rebound noise is produced.

FIG. 13 is a diagram showing the manner of generation of rebound nose in the ATC circuit 103. As the offset voltage Vref3 increases, the rebound noise shown in FIG. 13 becomes small, whereas no rebound noise is produced if the offset voltage Vref3 is taken larger. However, when the offset voltage Vref3 increases, the level identification allowance is further reduced (reception sensitivity is further degraded).

The present invention has been made to solve such conventional problems. It is an object of the present invention to provide a circuit and a method for controlling reception of an optical signal, which are capable of preventing the occurrence of noise during a null signal period and ensuring a sufficient level identification allowance (sensitivity of reception).

### SUMMARY OF THE INVENTION

According to one aspect of the present invention, there is provided an optical signal reception control circuit which includes an identifying circuit which identifies data included in a burst optical signal and which outputs data and an envelope generating circuit which detects the start of reception of the burst optical signal and which outputs an envelope signal corresponding to a reception period of the burst optical signal. The optical signal reception control circuit also includes a fixed signal output circuit which outputs a fixed signal of a predetermined level for a null signal period in which the data is not included and a selector which selects the output of the identifying circuit when the envelope signal is outputted and which selects the output of the fixed signal output circuit when the envelope signal is not outputted.

According to another aspect of the present invention, there is provided a method for controlling received burst optical signal which includes generating an envelope signal corresponding to a reception period of the burst optical signal; setting received signals included in the burst optical signal as received outputs during a period in which the envelope signal exists; and setting signals each having a proper level as received outputs as an alternative of the received signals during a period in which the envelope signal unexists.

The above and further objects and novel features of the invention will more fully appear from the following detailed description, appended claims and the accompanying drawings.

### BRIEF DESCRIPTION OF THE DRAWINGS

FIG. 1 is a diagram showing a configuration of an optical signal receiving device according to a first embodiment of the present invention.

FIG. 2 is a diagram illustrating an example of an internal configuration of a latch circuit shown in FIG. 1.

FIG. 3 is a timing chart of an envelope generating circuit shown in FIG. 1.

FIG. 4 is a diagram depicting a configuration of an optical signal receiving device according to a second embodiment of the present invention.

FIG. 5 is a timing chart of an envelope generating circuit shown in FIG. 3.

FIG. 6 is a diagram showing a configuration of an optical signal receiving device according to a third embodiment of the present invention.

FIG. 7 is a diagram showing an example of an internal configuration of a D-F/F shown in FIG. 6.

FIG. 8 is a timing chart of an envelope generating circuit shown in FIG. 6.

FIG. 9 is a diagram showing a configuration of a conventional optical signal receiving device.

FIG. 10is a timing chart of an ATC circuit shown in FIG. 9.

FIG. 11 is a diagram showing a configuration of another conventional optical signal receiving device.

FIG. 12 is a timing chart of an ATC circuit shown in FIG. 11.

### DETAILED DESCRIPTION OF THE PREFERRED EMBODIMENTS

An optical signal reception control circuit and method for controlling reception of an optical signal according to preferred embodiments of the present invention will be explained hereinafter with reference to figures. In order to simplify explanation, like elements are given like or corresponding reference numerals through this specification and figures. Dual explanations of the same elements are avoided.

### First Preferred Embodiment

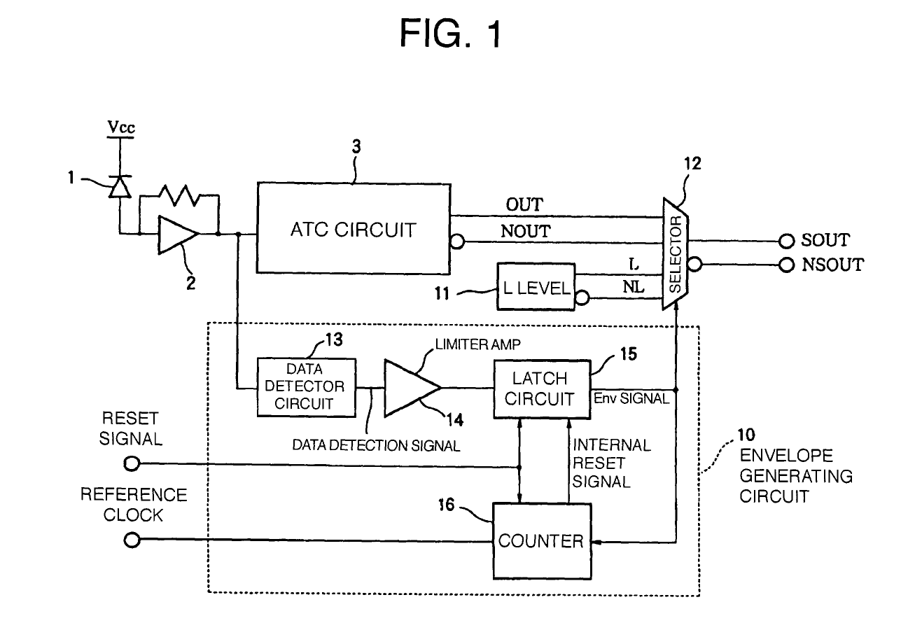

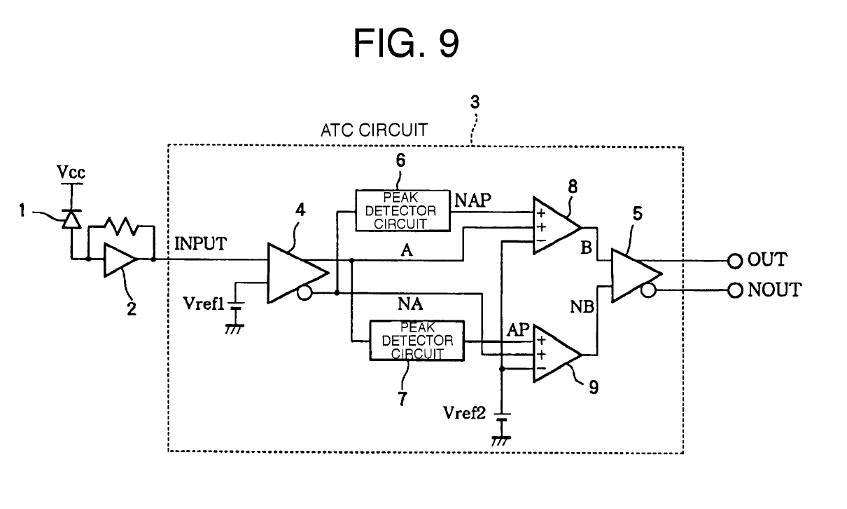

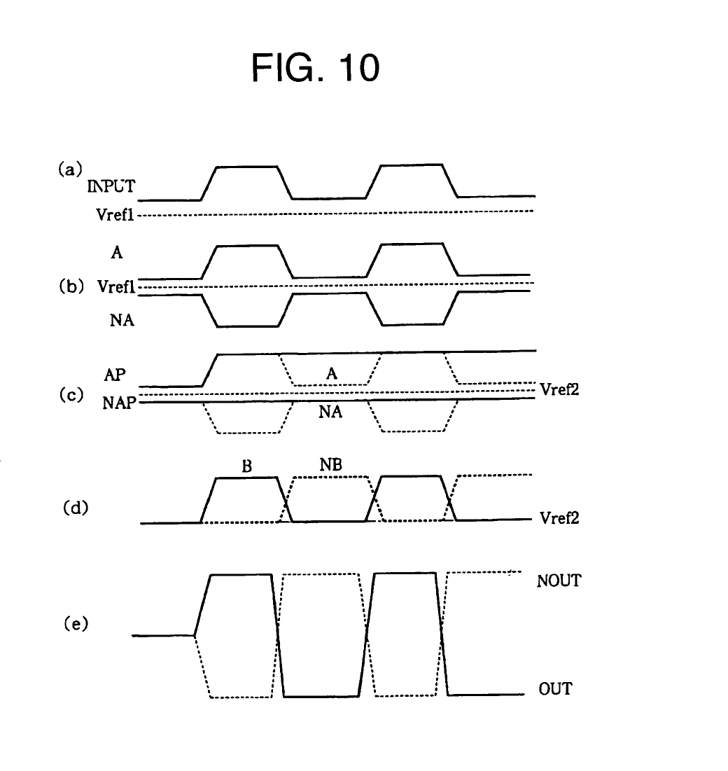

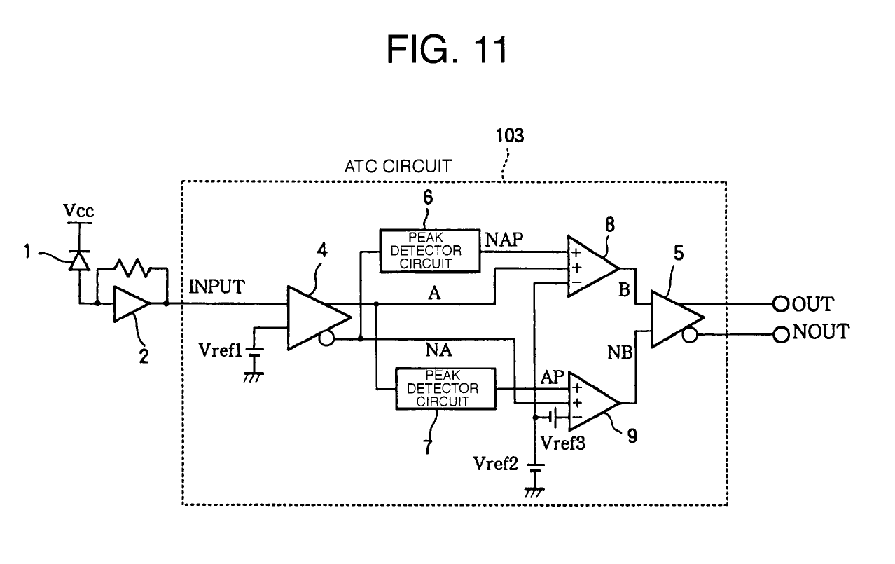

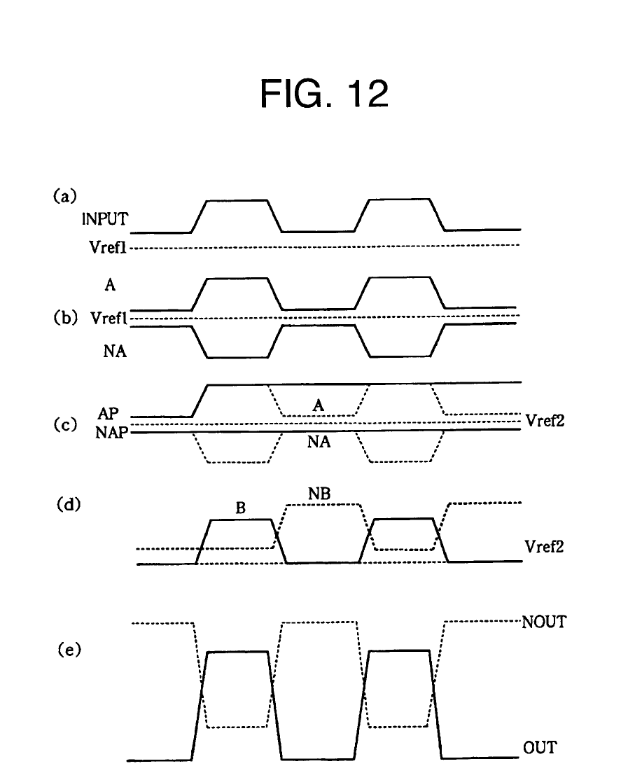

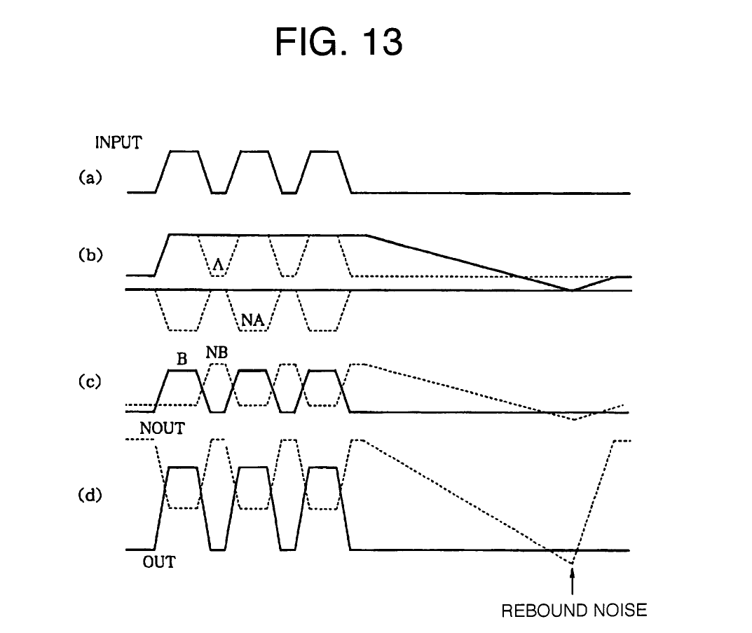

FIG. 1 is a diagram showing a configuration of an optical signal receiving device according to a first embodiment of the present invention. In FIG. 1, the same components as those in FIG. 9 are respectively identified by the same reference numerals. The optical signal receiving device according to the first embodiment comprises a photodiode 1, a pre-amplifier 2, an ATC (Automatic Threshold Control) circuit 3 (internal configuration thereof see FIG. 9), an L level generating circuit 11, a selector 12 and an envelope generating circuit 10. The L level generating circuit 11, the selector 12 and the envelope generating circuit 10 constitute an optical signal reception control circuit according to the first embodiment.

The optical signal receiving device according to the first embodiment is one wherein the conventional optical signal receiving device shown in FIG. 9 is provided with the envelope generating circuit 10, the L level generating circuit 11 and the selector 12.

The photodiode 1 receives therein a burst optical signal transmitted from an optical signal transmitting circuit, converts it into a photocurrent and outputs a burst signal of the photocurrent to the pre-amplifier 2.

The pre-amplifier 2 converts the burst signal of the photocurrent to a voltage signal, allows a burst signal of the voltage signal to branch into two, and outputs them to the ATC circuit 3 and the envelope generating circuit 10 respectively.

The ATC circuit 3 is identical to one provided for the conventional optical signal receiving device shown in FIG. 9 and has a configuration wherein an adder 9 is not provided with an offset voltage Vref3 for noise elimination.

The envelope generating circuit 10 includes a data detector circuit 13, a limiter amplifier 14, a latch circuit 15 and a counter 16. The envelope generating circuit 10 detects the start of reception of a burst signal, generates an Env (Envelope) signal corresponding to a reception period, and outputs the Env signal to the selector 12. A period for the generation of the Env signal is equivalent to a predetermined period pre-set so as to include a whole reception period of the burst signal.

The L level generating circuit 11 generates L level signals L and NL and outputs them to the selector 12. The L level signal L is a signal having an “L” level, whereas the L level signal NL is an inverted signal of the signal L and is of a signal having an “H” level. These L level signals L and NL are signals used as proper output levels in the absence of the signals.

The selector 12 outputs output signals (ATC signals) OUT and NOUT of the ATC circuit 3 as received output signals SOUT and NSOUT when the Env signal is outputted from the latch circuit 15. When no Env signal is outputted therefrom, the selector 12 outputs the L level signals L and NL as the received output signals SOUT and NSOU.

In the envelope generating circuit 10, the data detector circuit 13 detects data (first data of “H”) corresponding to a first bit of the burst signal and outputs a data detection signal to the limiter amplifier 14. Namely, the data detector circuit 13 detects the start of reception of the burst optical signal and outputs a data detection signal as a reception start detection signal.

The limiter amplifier 14 amplifies the input data detection signal to an amplitude level at which the latch circuit 15 is operable, and outputs it to the latch circuit 15.

The latch circuit 15 generates the Env signal during a period of from the input of the data detection signal to the input of an internal reset signal and outputs it to the selector 12 and the counter 16. Namely, when the start of reception of the burst optical signal is detected, the latch circuit 15 latches the data detection signal corresponding to the reception start detection signal therein and starts to generate the corresponding Env signal. When the internal reset signal is inputted from the counter 16 to the latch circuit 15, the latch circuit 15 is reset to stop the generation of the Env signal. Even when a reset signal is inputted from a reset input terminal, the latch circuit 15 is reset.

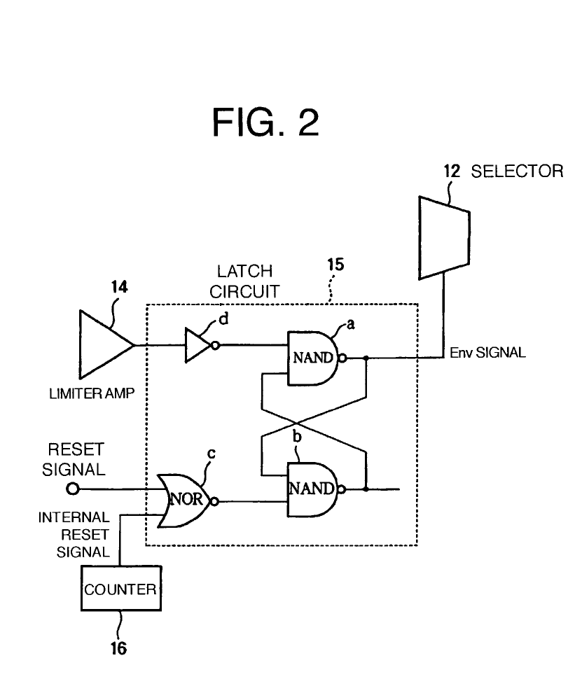

FIG. 2 is a diagram showing an example of an internal configuration of the latch circuit 15. In FIG. 2, the latch circuit 15 includes two-input NAND gates a and b, a two-input NOR gate c, and an inverter d. As shown in FIG. 2, the latch circuit 15 comprises, for example, an SR ffip-flop (SR-F/F). The latch circuit 15 shown in FIG. 2 is an asynchronous type SR-F/F operated with the signal outputted from the limiter amplifier 14 as a set input, and the internal reset signal outputted from the counter 16 and the reset signal sent from the reset input terminal as reset inputs respectively.

The counter 16 performs a count operation with a reference clock inputted from a clock input terminal as a clock input, the reset signal inputted from the reset input terminal as a reset input, and the Env signal outputted from the latch circuit 15 as a counter enable input respectively and outputs a carry signal to the latch circuit 15 as an internal reset signal when the value counted by the counter 16 reaches a preset value (count value for internal reset generation).

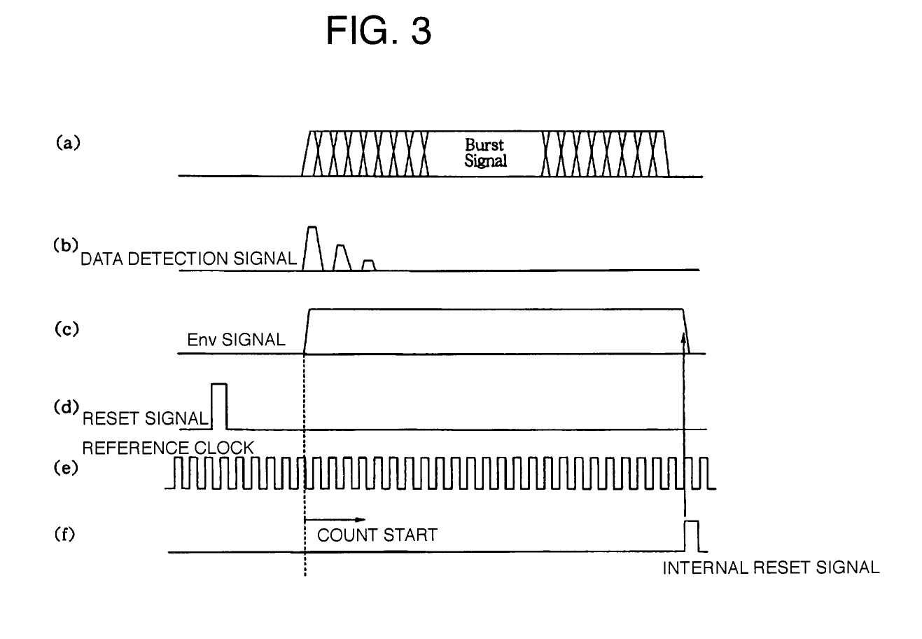

FIG. 3 is a timing chart of the envelope generating circuit 10 employed in the first embodiment. The operation of the optical signal receiving device according to the first embodiment will be described below with reference to FIGS. 1 through 3.

First, an amplified data detection signal corresponding to the output signal of the limiter amplifier 14 is taken “L” during a null signal period prior to the transmission/reception of the burst optical signal. This data detection signal of “L” is inputted to the inverter d of the latch circuit 15 shown in FIG. 2. Since, at this time, the reset signal and internal reset signal inputted to the NOR gate c are both taken “L”, the levels of signals outputted from the NAND gates a and b are not determined. Further, the count value of the counter 16 is not determined either.

However, when the burst signal is transmitted and received, such a reset signal as shown in FIG. 3(d) is always inputted before a few bits of a packet for the burst signal. According to the reset signal, the levels of the Env signal corresponding to the output signal of the NAND gate a and the output signal of the NAND gate b are determined, and the stop of the count operation of the counter 16 is determined, whereby the count value of the counter 16 is reset.

When such a reset signal of “H” as shown in FIG. 3(d) is inputted from the reset input terminal to the NOR gate c of the latch circuit 15 shown in FIG. 2 before a few bits of the packet for the burst signal, the latch circuit 15 is reset so that the Env signal corresponding to the output signal of the NAND gate a is determined to be “L”.

When the reset signal is inputted to the counter 16, the counter 16 resets a count value. The counter 16 stops counting while the Env signal is being taken “L”, and performs counting only during a period in which the Env signal is taken “H”. Thus, the counter 16 stops counting after the Env signal has been determined to be “L”.

During the period in which the Env signal is taken “L”, the selector 12 outputs L level signals L and NL sent from the L level generating circuit 11 as output signals SOUT and NSOUT. During the period in which the Env signal is taken “H”, the selector 12 outputs the ATC signals OUT and NOUT as output signals SOUT and NSOUT. Thus, the selector 12 outputs the output signals L and NL of the L level generating circuit 11 as output signals SOUT and NSOUT after the Env signal has been determined to be “L”.

Next, when the transmission/reception of the burst optical signal is started and the burst signal shown in FIG. 3(a) is inputted to the data detector circuit 13, the data detector circuit 13 detects data corresponding to a first bit of the burst signal and outputs such a data detection signal as illustrated in FIG. 3(b) to the limiter amplifier 14. The limiter amplifier 14 amplifies the input data detection signal and outputs the amplified data detection signal of “H” to the latch circuit 15.

The latch circuit 15 latches therein the data detection signal of “H” outputted from the limiter amplifier 14 and outputs such an Env signal of “H” as shown in FIG. 3(c) until such an internal reset signal as shown in FIG. 3(f) is inputted thereto. When the data detection signal of “H” outputted from the limiter amplifier 14 is inputted to the inverter d of the latch circuit 15 shown in FIG. 2, the Env signal corresponding to the output signal of the NAND gate a is caused to transition from “L” to “H”. Even if the data detection signal outputted from the limiter amplifier 14 is returned to “L” subsequently, the Env signal is held as “H” as it is. When the internal rest signal of “H” is inputted to the NOR gate c, the Env signal is returned to “L”.

When the Env signal changes from “L” to “H”, the counter 16 starts counting according to such a reference clock as shown in FIG. 3(e).

When the Env signal changes from “L” to “H”, the selector 12 switches the received output signals SOUT and NSOUT from the L level signals L and NL to the ATC signals OUT and OUT respectively.

Next, when the count value has reached a pre-set internal reset setting value, the counter 16 outputs the internal reset signal of “H” shown in FIG. 3(f) to the latch circuit 15 with its carry signal as an internal reset signal. The internal reset setting value referred to above is set in such a manner that the internal reset signal is outputted since the completion of reception of the burst signal.

The latch circuit 15 is reset in response to the input internal reset signal and thereby terminates the output of the Env signal therefrom. When the internal reset signal of “H” is inputted to the NOR gate c of the latch circuit 15 shown in FIG. 2, the output signal of the NAND gate b is caused to transition from “L” to “H”. Since, at this time, the output signal of the limiter amplifier 14 has already been brought to “L”, the Env signal corresponding to the output signal of the NAND gate a changes from “H” to “L” when the output signal of the NAND gate b is changed to When the Env signal changes from “H” to “L”, the counter 16 stops its count operation. Further, the selector 12 switches the received output signals SOUT and NSOUT from the ATC signals OUT and NOUT to the L level signals L and NL respectively.

In the first embodiment as described above, when the start of reception of the burst signal is detected, the Env signal of “H” is generated from the start of its reception to the elapse of a predetermined time. During a period in which the Env signal is taken “H”, the ATC signals OUT and NOUT are outputted as the received output signals SOUT and NSOUT. During a period in which the Env signal is taken “L”, the L level signals L and NL are outputted as the received output signals SOUT and NSOUT as an alternative to the ATC signals OUT and NOUT.

Since the ATC circuit 3 is configured so as not to provide the offset voltage Vref3, the output signals OUT and NOUT of the ATC circuit 3 produce noise due to the oscillations of the comparator during a null signal period. Since the ATC signal NOUT is discharged with a given time constant when the reception of the burst signal is completed, the output signals OUT and NOUT of the ATC circuit 3 produce rebound noise as shown in FIG. 13(d) during the null signal period.

Thus, in the first embodiment, the Env signal is taken “H” to pass the ATC signals OUT and NOUT during the reception period of the burst signal. During the null signal period in which the noise is produced, the Env signal is rendered “L” to output the L level signals L and NL, whereby the noise contained in each output signal of the ATC circuit 3 is prevented from being outputted.

As means for generating timing provided to cause the Env signal to transition to “H”, the data detector circuit 13 for detecting the start of reception of the burst signal and the limiter amplifier 14 are provided. As means for generating timing provided to cause the Env signal to transition to “L”, the counter 16 is provided.

When the counter 16 starts counting when the Env signal is changed to “H”, and counts up to the pre-set internal reset generating count value, the counter 16 outputs an internal reset signal to the latch circuit 15 and resets the latch circuit 15 to thereby transition the Env signal to “L”.

Accordingly, the “H” period of the Env signal in the first embodiment corresponds to a predetermined period from the start of counting by the counter 16 to the time when the count value reaches the internal reset generating count value.

It is necessary to cause the Env signal to transition to “L” after the completion of reception of the burst signal and before the production of the noise in the output signal of the ATC circuit 3. It is necessary to set the internal reset generating count value of the counter 16 in this way. This condition can easily be satisfied by pre-setting the internal reset generating count value in accordance with a packet length of the burst signal when the packet length thereof has been defined.

According to the first embodiment as described above, the Env signal is generated which is brought to the predetermined period “H” pre-set according to the packet length from the start of reception of the burst signal. During the period for reception of the burst signal, the Env signal is rendered “H” to pass the ATC signals. During the null signal period in which the noise is produced in the output signal of the ATC circuit, the Env signal is rendered “L” to output the L level signals. Therefore, the noise is no longer outputted as the received output signals.

Since it is not necessary to provide the offset voltage for the ATC circuit, a sufficient level identification allowance and sufficient light-reception sensitivity can be ensured, and a signal level in the neighborhood of the minimum light-reception level can be determined. Thus, performance improvements such as an improvement in the sensitivity of optical reception, enlargement of a dynamic range for reception can be realized and a high-quality optical communication system can be configured.

### Second Preferred Embodiment

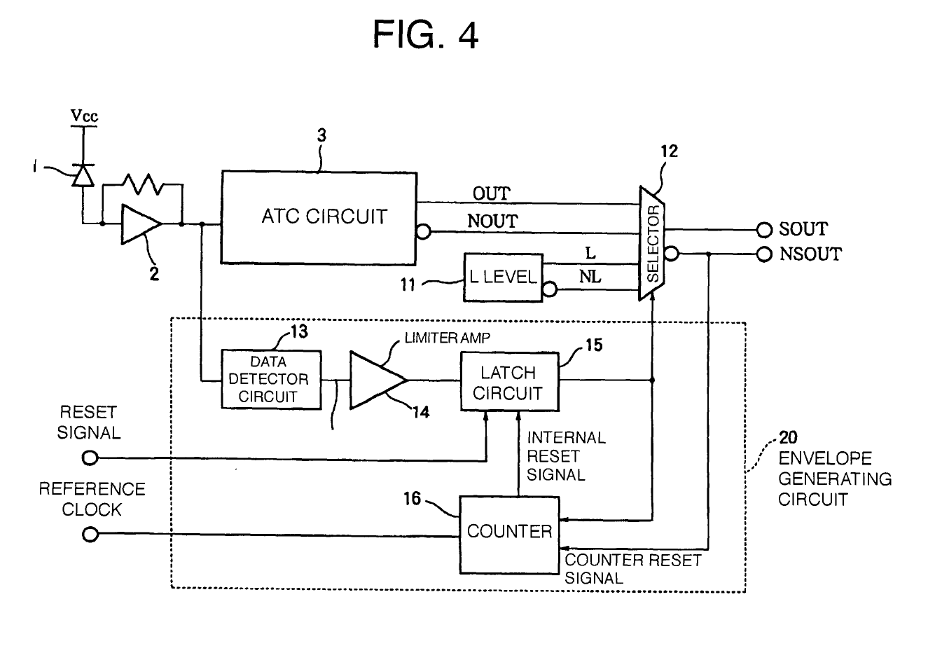

FIG. 4 is a diagram showing a configuration of an optical signal receiving device according to a second embodiment of the present invention. In FIG. 4, the same components as those shown in FIG. 1 are respectively identified by the same reference numerals. The optical signal receiving device according to the second embodiment comprises a photodiode 1, a pre-amplifier 2, an ATC circuit 3 (internal configuration thereof see FIG. 9), an envelope generating circuit 20, an L level generating circuit 11, and a selector 12. The L level generating circuit 11, the selector 12 and the envelope generating circuit 20 constitute an optical signal reception control circuit according to the first embodiment.

The optical signal receiving device according to the second embodiment is one wherein the envelope generating circuit 10 in the optical signal receiving device according to the first embodiment (see FIG. 1) is configured as the envelope generating circuit 20.

The envelope generating circuit 20 includes a data detector circuit 13, a limiter amplifier 14, a latch circuit 15, and a counter 16. The envelope generating circuit 20 detects the start of reception of a burst signal to thereby generate an Env signal corresponding to a reception period and outputs the Env signal to the selector 12. A period for the generation of the Env signal corresponds to a variable period which includes a whole reception period of the burst signal and corresponds to a packet length of the burst signal.

The envelope generating circuit 20 employed in the second embodiment takes a configuration wherein in the envelope generating circuit 10 employed in the first embodiment, a received output signal SOUT sent from the selector 12 is used as a reset signal (counter reset signal) for the counter 16. While the reset signal inputted from the reset input terminal is inputted to the latch circuit 15 and the counter 16 in the first embodiment, it is inputted to the latch circuit 15 alone and not inputted to the counter 16 in the second embodiment.

The counter 16 of the envelope generating circuit 20 performs a count operation with a reference clock inputted from a clock input terminal as a clock input, the counter reset signal inputted from the selector 12 as a reset input, and the Env signal outputted from the latch circuit 15 as a counter enable input respectively, and outputs a carry signal to the latch circuit 15 as an internal reset signal when the value counted by the counter 16 reaches a preset internal reset generating count value.

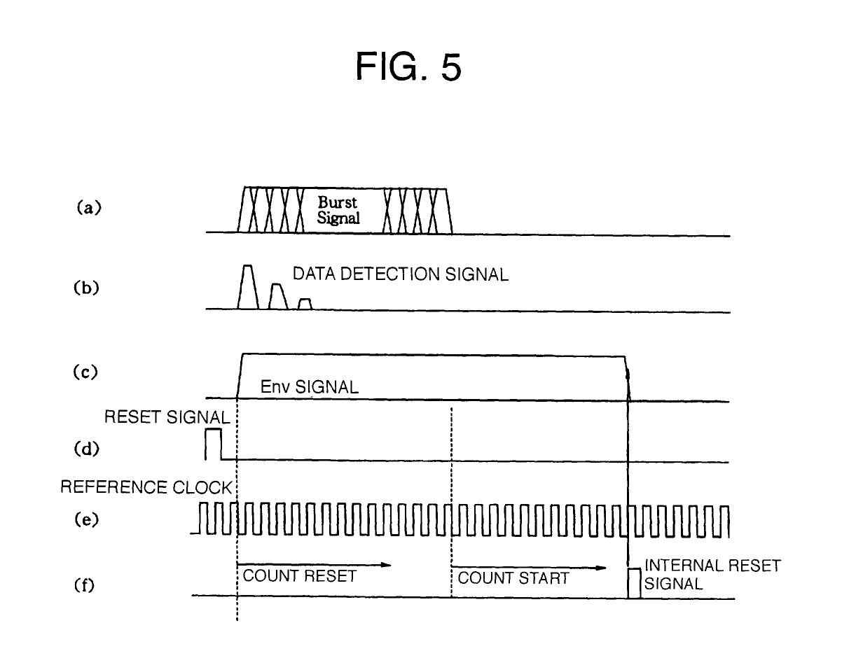

FIG. 5 is a timing chart of the envelope generating circuit 20 employed in the second embodiment. The operation of the optical signal receiving device according to the second embodiment will be described below with reference to FIGS. 4 and 5.

When such a reset signal of “H” as shown in FIG. 5(d) is inputted to the reset input terminal before a few bits of a packet for the burst signal, the latch circuit 15 is reset in a manner similar to the first embodiment so that the Env signal is determined to be “L”. The counter 16 stops counting until the Env signal changes to “H” since the determination of “L” thereof, and the selector 12 outputs L level signals L and NL as received output signals SOUT and NSOUT.

Next, when the transmission/reception of the burst optical signal is started and such a burst signal as shown in FIG. 5(a) is inputted to the data detector circuit 13, the data detector circuit 13, the limiter amplifier 14 and the latch circuit 15 cause the Env signal to transition from “L” to “H” as shown in FIG. 5(c) in a manner similar to the first embodiment. Namely, the data detector circuit 13 detects data corresponding to a first bit of the burst signal and outputs such a data detection signal as illustrated in FIG. 5(b) to the limiter amplifier 14. The limiter amplifier 14 amplifies the input data detection signal and outputs the amplified data detection signal to the latch circuit 15. The latch circuit 15 latches therein the data detection signal outputted from the limiter amplifier 14 and outputs the Env signal of “H” until such an internal reset signal as shown in FIG. 5(f) is inputted thereto.

When the Env signal changes from “L” to “H”, the selector 12 switches received output signals OUT and NOUT to their corresponding ACT signals OUT and NOUT in a manner similar to the first embodiment and outputs the ATC signal OUT to the counter 16 as the counter reset signal.

When the Env signal changes from “L” to “H”, the counter 16 is capable of performing a count operation. On the other hand, the ATC signal OUT is inputted to the counter 16 as the counter reset signal substantially simultaneously with the transition of the Env signal. Therefore, the counter 16 is reset during the transmission/reception of the burst signal each time the ATC signal OUT of “H” is inputted thereto, before its count value reaches an internal reset generating count value, and does not output the internal reset signal accordingly.

Next, when the transmission/reception of the burst signal is completed, no counter reset signal is inputted to the counter 16 (the counter reset signal remains held at “L”). Therefore, the counter 16 starts counting without being reset. When the count value reaches the internal reset generating count value, the counter 16 outputs such an internal reset signal of “H” as shown in FIG. 5(f) to the latch circuit 15 with its carry signal as the internal reset signal.

In a manner similar to the first embodiment, the latch circuit 15 is reset in response to the input internal reset signal of “H” and thereby returns the Env signal from “H” to “L” as shown in FIG. 5(c) (the output of the Env signal is completed).

When the Env signal changes from “H” to “L”, the counter 16 stops counting, and the selector 12 switches the output signals SOUT and NSOUT from the ATC signals OUT and NOUT to the L level signals L and NL respectively.

While the internal reset generating count value of the counter 16 has been set according to the predetermined packet length of the burst optical signal in the first embodiment, the packet length is set by a cell called a mini slot according to, for example; an ITU-T recommendation G983.1, and the mini slot can be assigned a bandwidth from 3 through 55 [bytes]. Since the packet length cannot be recognized in advance when the packet length of the burst signal changes in this way, the internal reset generating count value cannot be preset either.

Thus, the second embodiments takes a configuration wherein as shown in FIG. 3, the received output signal OUT is used as the counter reset signal and the counting of the counter 16 is started from the completion of reception of the burst signal, whereby the period of “H” of the Env signal is also varied according to the packet length of the burst signal, thereby allowing its application even to the burst signal whose packet length varies.

In the second embodiment, when the counter 16 starts counting when the reception of the burst signal is completed, and counts up to the preset internal reset generating count value, the counter 16 outputs the internal reset signal to the latch circuit 15 to reset the latch circuit 15, where the Env signal is changed to “L”.

Thus, the period of “H” of the Env signal employed in the second embodiment is equivalent to a period corresponding to the sum of a variable period from the start of reception of the burst signal to its completion and a predetermined period from the start of counting by the counter 16 to the attainment of its count value to the internal reset generating count value.

The internal clock generating count value is set to a value corresponding to the same sign continuous proof strength of the ATC circuit 3. Namely, even when the reception of the burst signal is completed, the internal clock generating count value is set to a time interval (number of bits) in which the values (“0” or “1”) of the ATC signals OUT and NOUT have been determined according to the discharge time constants of the peak detector circuits 6 and 7 (see FIG. 9) of the ATC circuit 3. This is equivalent to a time immediately preceding the occurrence of the rebound noise shown in FIG. 13.

The reason why the Env signal is held “H” till the elapse of a predetermined time even when the reception of the burst signal is completed, is that the same sign continuous (e.g., “0” continuous) period in the reception period and a null signal period during which the burst signal is not received, are distinguished from each other. In the ITU-T recommendation G.983.1, for example, the same sign continuous proof strength is defined as 72 bits. Namely, there is a case in which “0” or “1” is continuous over or in 72-bits. The continuation of the same sign in the form of 72-bits or more in reverse is impossible.

There is a possibility that a problem will arise in that when the internal clock generating count value is not set to the value corresponding to the same sign continuous proof strength and is a variable length burst signal including continuous data of “0”, the continuous data of “0” is terminated where the Env signal changes to “L” when the continuous data of “0” is received upon the start of reception, and when the Env signal changes to “H” upon reception of a data signal of “1”, data of “1” corresponding to a first bit subsequent to the continuous data of “0” is not reproduced due to a phase problem. In order to avoid such a problem, the Env signal is held “H” in the second embodiment until the predetermined time elapses even if the reception of the burst signal is completed.

The same sign continuous proof strength of the ATC circuit 3 depends on the time necessary for self-discharge of each peak detector circuit. Namely, it is determined according to the amplitude and time constant of the input burst signal. When the “0” data is continuous in the burst signal, for example, the peak detector circuit is self-discharged according to its time constant and is hence unable to maintain a peak value. When the peak value cannot be held, the ATC signals might produce noise during the reception period in which the “0” data is continuous. When the reception of the burst signal is completed, noise is produced because it is equivalent to the fact that the “0” data is continuous. In order to avoid the occurrence of these noise, a self-discharge time interval of each peak detection circuit is calculated and the internal reset generating counter value of the counter 16 is set such that the Env signal is transitioned to “L” before its calculation.

Thus, since the second embodiment has a counter function for starting counting when the burst optical signal is terminated, regardless of the packet length of the burst optical signal, it produces an effect in varying the mini slot.

According to the second embodiment as described above, since the Env signal is generated which takes the period “H” corresponding to the sum of the variable period from the start of reception of the burst signal to its completion and the pre-set predetermined period subsequent to the variable period, the variable length burst signal also produces an effect similar to the first embodiment.

### Third Preferred Embodiment

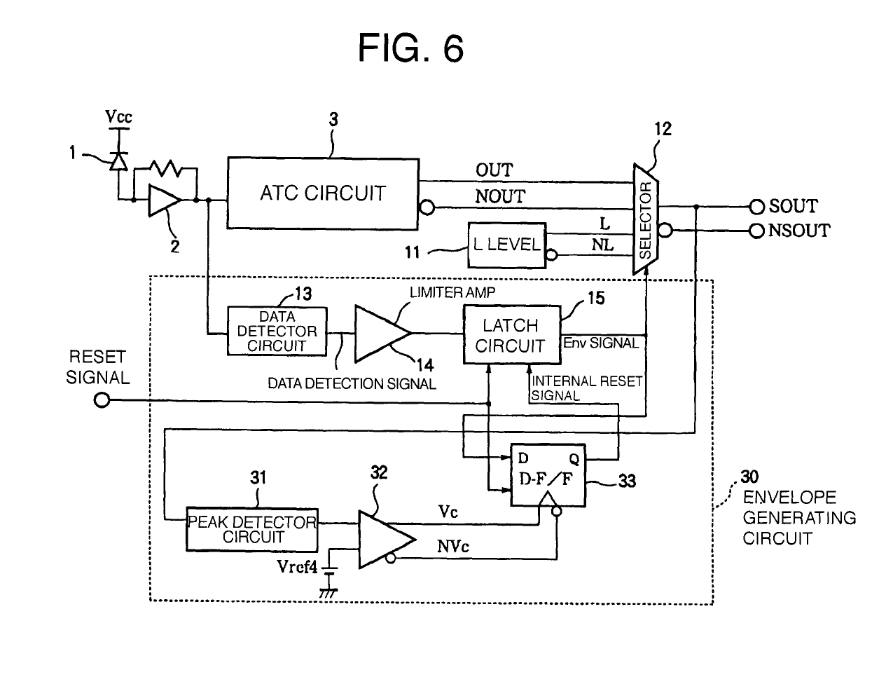

FIG. 6 is a diagram showing a configuration of an optical signal receiving device according to a third embodiment of the present invention. In FIG. 6, the same components as those shown in FIG. 1 or 4 are respectively identified by the same reference numerals. The optical signal receiving device according to the third embodiment comprises a photodiode 1, a pre-amplifier 2, an ATC circuit 3 (internal configuration thereof see FIG. 9), an envelope generating circuit 30, an L level generating circuit 11, and a selector 12. The L level generating circuit 11, the selector 12 and the envelope generating circuit 30 constitute an optical signal reception control circuit according to the third embodiment.

The optical signal receiving device according to the third embodiment is one wherein the envelope generating circuit 10 or 20 in the optical signal receiving device according to the first or second embodiment (see FIG. 1 or FIG. 4) is configured as the envelope generating circuit 30.

Each of the envelope generating circuits employed in the first and second embodiments has the configuration wherein the reference clock is inputted to the counter 16 and the counter 16 counts the reference clock up to the set value, thereby causing the Env signal to transition to “L”. In the third embodiment, however, the envelope generating circuit for allowing the Env signal to transition to “L” without using the reference clock will be described. Thus, the counter 16 is not used as means for causing the Env signal to transition to “L” in the third embodiment.

The envelope generating circuit 30 includes a data detector circuit 13, a limiter amplifier 14, a latch circuit 15, a peak detector circuit 31, a differential amplifier 32, and a D flip-flop (D-F/F) 33. The envelope generating circuit 30 detects the start of reception of a burst signal to thereby generate an Env signal corresponding to a reception period and outputs the Env signal to the selector 12. A period for the generation of the Env signal corresponds to a variable period which includes a whole reception period of the burst signal and corresponds to a packet length of the burst signal in a manner similar to the second embodiment.

The envelope generating circuit 30 according to the third embodiment takes a configuration wherein in the envelope generating circuit 10 or 20 according to the first embodiment or second embodiment, the peak detector circuit 31, the differential amplifier 32, and the D-F/F 33 are provided as an alternative to the counter 16. These peak detector circuit 31, differential amplifier 32 and D-F/F 33 produce an internal reset signal for causing the Env signal to transition to “L” using a received output signal SOUT sent from the selector 12 without using the reference clock.

The peak detector circuit 31 detects the peak of the received output signal SOUT sent from the selector 12 and outputs a peak detected voltage Vpk to the differential amplifier 32.

The amplifier 32 outputs difference voltages Vc and NVc each developed between the peak detected voltage Vpk ad a reference voltage Vref4.

When the D-F/F 33 detects the falling edge (rising edge of the difference voltage NVc) of the difference voltage Vc, the D-F/F 33 causes an output signal used as the internal reset signal to transition.

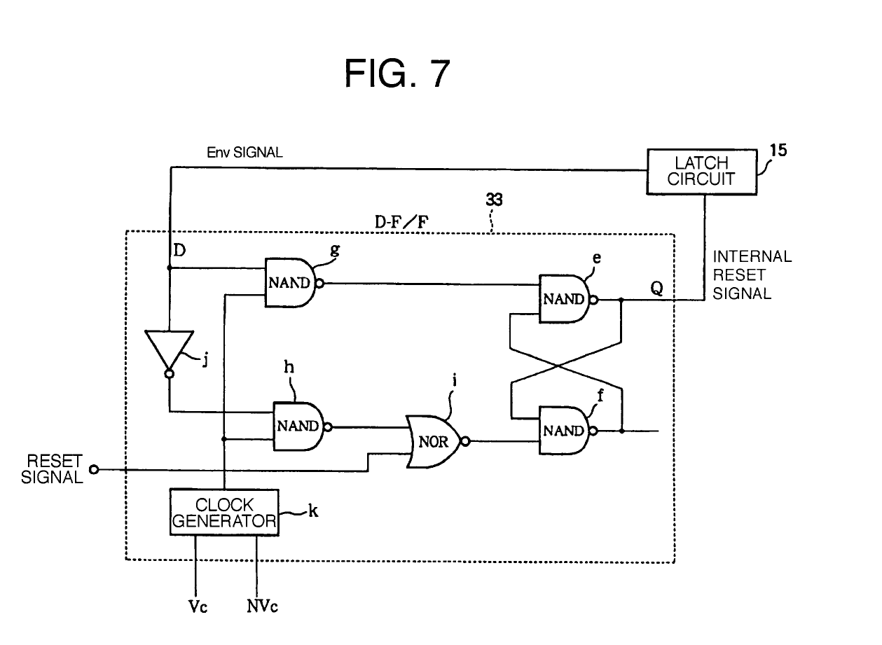

FIG. 7 is a diagram showing an example of an internal configuration of the D-F/F 33. In FIG. 7, the D-F/F 33 comprises two-input NAND gates e, f, g and h, a two-input NOR gate i, an inverter j and a clock generator k. The D-F/F 33 shown in FIG. 7 is operated with an Env signal outputted from a latch circuit 15 as a data input (input signal at a data input terminal D), a reset signal sent from a reset input terminal as a reset input, and the difference voltages Vc and NVc outputted from the differential amplifier 32 as clock inputs, and causes an output signal at a data output terminal Q to transition. The clock generator k generates a clock pulse of “H” when the difference voltage Vc changes from “H” to “L” and the difference voltage NVc changes from “L” to “H”, and outputs the clock pulse of “H” to the NAND gates g and h.

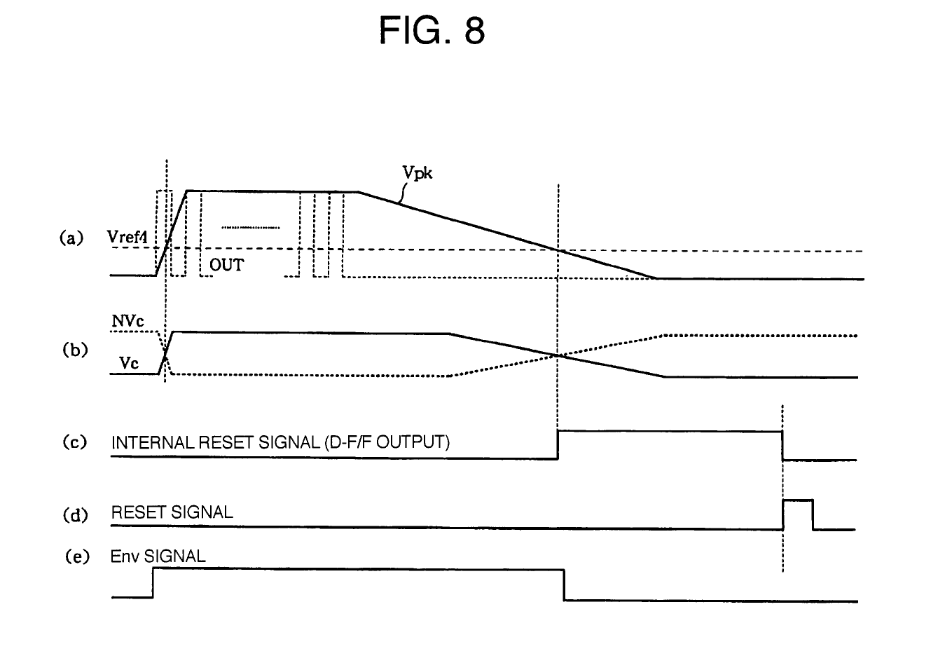

FIG. 8 is a timing chart of the envelope generating circuit 30 employed in the third embodiment. The operation of the optical signal receiving device according to the third embodiment will be described below using FIGS. 6 through 8.

When a reset signal is inputted to the latch circuit 15 through the reset input terminal before a few bits of a packet for a burst signal, the latch circuit 15 is reset in a manner similar to the first embodiment, so that an Env signal is determined to be “L”. When the reset signal is inputted from the reset input terminal to the NOR gate h of the D-F/F 33 shown in FIG. 7, the D-F/F 33 is reset so that an internal reset signal corresponding to an output signal (Q output signal) of the NAND gate e is determined to be “L”.

Until the Env signal changes to “H” since it has been determined to be “L”, the selector 12 outputs L levels L and NL as their corresponding output signals SOUT and NSOUT. Therefore, a peak detected voltage Vpk outputted from the peak detector circuit 31 is taken “L” as shown in FIG. 8(a), a difference voltage NVc inputted to the NAND gate g of the D-F/F 33 of FIG. 7 from the differential amplifier 32 is taken “H” as shown in FIG. 8(b), and a difference voltage Vc inputted to the NOR gate h of the D-F/F 33 of FIG. 7 from the differential amplifier 32 is taken “L”, respectively.

Next, when the transmission/reception of a burst optical signal is started and such a burst signal as shown in FIG. 8(a) is inputted to the data detector circuit 13, the data detector circuit 13, the limiter amplifier 14 and the latch circuit 15 cause the Env signal to transition from “L” to “H” as shown in FIG. 8(e) in a manner similar to the first and second embodiments. Namely, the data detector circuit 13 detects data corresponding to a first bit of the burst signal and outputs such a data detection signal to the limiter amplifier 14. The limiter amplifier 14 amplifies the input data detection signal and outputs the amplified data detection signal to the latch circuit 15. The latch circuit 15 latches therein the data detection signal outputted from the limiter amplifier 14 and outputs the Env signal of “H” to the selector 12 and the data input terminal D (the NAND gate g and the inverter j) of the D-F/F 33 until such an internal reset signal as shown in FIG. 8(c) is inputted thereto.

When the Env signal changes from “L” to “H”, the selector 12 switches received output signals SOUT and NSOUT to their corresponding ACT signals OUT and NOUT in a manner similar to the first and second embodiments and outputs the ATC signal OUT to the peak detector circuit 31.

The peak detector circuit 31 detects the peak of the input ATC signal OUT and outputs such a peak detected voltage Vpk to the differential amplifier 32. Namely, the peak detector circuit 31 is charged based on the input ATC signal of “H”, so that the peak detected voltage Vpk rises as shown in FIG. 8(a) according to this charge.

When Vpk≧Vref4, the differential amplifier 32 causes the difference voltage Vc to transition from “L” to “H” and the difference voltage NVc to transition from “H” to “L” as shown in FIG. 8(b), respectively, and outputs the difference voltage NVc of “H” and the difference voltage Vc of “L” to the D-F/F 33.

Since, however, the D-F/F 33 is not operated on the rising edge (falling edge of the difference voltage NVc) of the difference voltage Vc, the internal reset signal corresponding to the Q output signal of the D-F/F 33 is not transitioned while remained held at “L” as shown in FIG. 8(c) even if the difference voltage Vc rises (the difference voltage NVc falls) as described above.

Next, when the transmission/reception of the burst signal is completed, no ATC signal OUT of “H” is inputted to the peak detector circuit 31. Therefore, the peak detector circuit 31 is discharged according to its discharge time constant, so that the peak voltage Vpk drops due to the discharge as shown in FIG. 8(a).

When Vpk<Vref4, the differential amplifier 32 causes the difference voltage Vc to transition from “H” to “L” and allows the difference voltage NVc to transition from “L” to “H” as shown in FIG. 8(b) respectively, and outputs these difference voltages to the D-F/F 33.

When the difference voltage Vc falls (the difference voltage NVc rises), the D-F/F 33 detects the falling edge of the difference voltage Vc, latches the Env signal of “H” indicative of the data input signal therein, allows the internal reset signal corresponding to the Q output signal to transition from “L” to “H”, and outputs the internal reset signal of “H” to the latch circuit 15. Namely, when the difference voltage Vc changed from “H” to “L” and the difference voltage NVc changed from “L” to “H” are respectively inputted to the clock generator k of FIG. 7, the clock generator k outputs a clock pulse of “H” to the NAND gates g and h. In response to the clock pulse of “H”, the output signal of the NAND gate g changes from “H” to “L”, and the output signal of the NAND gate e, which is indicative of the internal reset signal, is transitioned from “L” to “H” in response to the transition of the output signal of the NAND gate g.

In a manner similar to the first and second embodiments, the latch circuit 15 is reset in response to the input internal reset signal of “H” to thereby return the Env signal from “H” to “L” as shown in FIG. 8(e) (the output of the Env signal is completed).

When the Env signal changes from “H” to “L”, the selector 12 switches the received output signals SOUT and NSOUT from the ATC signals OUT and NOUT to the output signals L and NL of the L level generating circuit 11 in a manner similar to the first and second embodiments.

Next, when such a reset signal of “H” as shown in FIG. 8(d) is inputted to the D-F/F 33 through the reset input terminal, the D-F/F 33 is reset in response to the reset signal to return the internal reset signal indicative of the Q output signal from “H” to “L” as shown in FIG. 8(c) (the output of the internal reset signal is terminated). Namely, the reset signal of “H” is inputted to the NOR gate i of FIG. 7, so that the output signal of the NOR gate i is changed from “H” to “L”. In response to the transition of the output signal of the NOR gate i, the output signal of the NAND gate f is allowed to transition from “L” to “H”. In response to the transition of the output signal of the NAND gate f, the internal reset signal corresponding to the output signal of the NAND gate e changes from “H” to “L”.

Conditions necessary for the third embodiments are the following (1) and (2).

(1) To set the discharge time constant of the peak detected voltage Vpk (peak detector circuit 31) shorter than the discharge time constant of the ATC circuit for the purpose of removal of rebound noise.

(2) To set the charge time of the peak detected voltage Vpk (peak detector circuit 31) shorter than the minimum packet length of the burst signal.

If these conditions are met, then the optical signal receiving device according to the third embodiment can be easily realized.

According to the third embodiment as described above, since the peak of the ATC signal OUT is detected and the internal reset signal is generated, an advantageous effect similar to the second embodiment can be obtained without using the counter that needs the reference clock. Further, since various circuits that constitute the counter, can be reduced, power consumption can be lessened.

Further, since the first or second embodiment has the potential that when the configuration using the counter is designed as an IC, this will exert an influence on the ATC circuit 3 at a point of a change in the input reference clock, it is difficult to bring the ATC circuit 3 and the envelope signal generating circuit 10 or 20 into the same IC. Since, however, the third embodiment needs no reference clock, the ATC circuit 3 and the envelope generating circuit 30 can be integrated into the same IC. A product (e.g., optical transmission module) using this IC can be reduced in size.

According to the present invention as described above, an advantage is brought about in that an optical signal receiving device can be realized which produces no noise during a null signal period and includes a sufficient level identification allowance and sufficient sensitivity of reception.

While the preferred form of the present invention has been described, it is to be understood that modifications will be apparent to those skilled in the art without departing from the spirit of the invention. The scope of the invention is to be determined solely by the following claims.

What is claimed is:

1. An optical signal reception control circuit for identifying and outputting data included in a burst optical signal during a reception period in which the burst optical signal is included and outputting null signals each having a proper level during a null signal period in which the burst optical signal is not included, comprising:
an envelope generating circuit for detecting the start of reception of the burst optical signal and outputting an envelope signal corresponding to the reception period;
a null signal level generating circuit for outputting the null signals each having the proper level; and
a selector for selecting and outputting the identified data when the envelope signal is outputted and selecting and outputting the null signals when the envelope signal is not outputted.

2. The optical signal reception control circuit according to claim 1, wherein the envelope generating circuit includes,
a circuit for detecting the start of reception of the burst optical signal;
a circuit for generating the envelope signal when the start of reception thereof is detected; and
a circuit for stopping the generation of the envelope signal when a predetermined time has elapsed since the start of generation of the envelope signal.

3. The optical signal reception control circuit according to claim 1, wherein the envelope generating circuit includes,
a circuit for detecting the start of reception of the burst optical signal;
a circuit for generating the envelope signal when the start of reception thereof is detected; and
a circuit for stopping the generation of the envelope signal when a predetermined time has elapsed since the completion of reception of the burst optical signal.

4. The optical signal reception control circuit according to claim 1, wherein the envelope generating circuit includes,
a circuit for detecting the start of reception of the burst optical signal;
a circuit for generating the envelope signal when the start of reception thereof is detected; and
a circuit for detecting a peak of the output of the identified data and stopping the generation of the envelope signal when the peak thereof is varied to a predetermined level.

5. An optical signal reception control circuit, comprising:
an identifying circuit which identifies data included in a burst optical signal and which outputs data;
an envelope generating circuit which detects the start of reception of the burst optical signal and which outputs an envelope signal corresponding to a reception period of the burst optical signal;
a fixed signal output circuit which outputs a fixed signal of a predetermined level for a null signal period in which the data is not included; and
a selector which selects the output of the identifying circuit when the envelope signal is outputted and which selects the output of the fixed signal output circuit when the envelope signal is not outputted.

6. The optical signal reception control circuit according to claim 5, wherein the envelope generating circuit includes,
a first circuit which detects the start of reception of the burst optical signal;
a second circuit which generates the envelope signal when the start of reception thereof is detected; and
a third circuit which stops the generation of the envelope signal when a predetermined time has elapsed since the start of generation of the envelope signal.

7. The optical signal reception control circuit according to claim 5, wherein the envelope generating circuit includes,
a first circuit which detects the start of reception of the burst optical signal;
a second circuit which generats the envelope signal when the start of reception thereof is detected; and
a third circuit which stops the generation of the envelope signal when a predetermined time has elapsed since the completion of reception of the burst optical signal.

8. The optical signal reception control circuit according to claim 5, wherein the envelope generating circuit includes,
a first circuit which detects the start of reception of the burst optical signal;
a second circuit which generates the envelope signal when the start of reception thereof is detected; and
a third circuit which detects a peak of the output of the level identifying circuit and stopping the generation of the envelope signal when the peak thereof is varied to a predetermined level.

9. A method for controlling received burst optical signal comprising:
generating an envelope signal corresponding to a reception period of the burst optical signal;
setting received signals included in the burst optical signal as received outputs during a period in which the envelope signal exists; and
setting signals each having a proper level as received outputs as an alternative of the received signals during a period in which the envelope signal unexists.

10. The method according to claim 9, wherein the envelope signal is generated during a period from the start of reception of the burst optical signal to the elapse of a predetermined time.

11. The method according to claim 9, wherein the envelope signal is generated during a period from the start of reception of the burst optical signal to the elapse of a predetermined time from the completion of reception of the burst optical signal.

12. The method according to claim 9, wherein the envelop signal is generated during a period from the start of reception of the burst optical signal to a change of from a detected peak of each of the received signals to a predetermined level.

13. A signal reception control circuit, comprising:
an identifying circuit which identifies data included in a burst signal and which outputs data;
an envelope generating circuit which detects the start of reception of the burst signal and which outputs an envelope signal corresponding to a reception period of the burst signal;
a fixed signal output circuit which outputs a fixed signal of a predetermined level for a null signal period in which the data is not included; and
a selector which selects the output of the identifying circuit when the envelope signal is outputted and which selects the output of the fixed signal output circuit when the envelope signal is not outputted.

14. The signal reception control circuit according to claim 13, wherein the envelope generating circuit includes,
a first circuit which detects the start of reception of the burst signal;
a second circuit which generates the envelope signal when the start of reception thereof is detected; and
a third circuit which stops the generation of the envelope signal when a predetermined time has elapsed since the start of generation of the envelope signal.

15. The signal reception control circuit according to claim 13, wherein the envelope generating circuit includes,
a first circuit which detects the start of reception of the burst signal;
a second circuit which generates the envelope signal when the start of reception thereof is detected; and
a third circuit which stops the generation of the envelope signal when a predetermined time has elapsed since the completion of reception of the burst signal.

16. The signal reception control circuit according to claim 13, wherein the envelope generating circuit includes,
a first circuit which detects the start of reception of the burst signal;
a second circuit which generates the envelope signal when the start of reception thereof is detected; and
a third circuit which detects a peak of the output of the level identifying circuit and stopping the generation of the envelope signal when the peak thereof is varied to a predetermined level.
